(19) United States
(12) Patent Application Publication
(10) Pub. No.: US 2023/0322603 A1
(43) Pub. Date: Oct. 12, 2023

(54) MINIMIZING CRYSTALLINE RHODIUM-PLATINUM DEFECT FORMATION IN GLASS MANUFACTURED IN PRECIOUS METAL SYSTEMS

(71) Applicant: CORNING INCORPORATED, CORNING, NY (US)

(72) Inventors: CAROL ANN CLICK, CORNING, NY (US); MATTHEW JOHN DEJNEKA, CORNING, NY (US); MARTIN HERBERT GOLLER, CAMPBELL, NY (US); ZAKARIYA RADWAN KHAYAT, BILLERICA, MA (US); SUSAN LEE SCHIEFELBEIN, ITHACA, NY (US)

(21) Appl. No.: 18/022,313

(22) PCT Filed: Aug. 9, 2021
(86) PCT No.: PCT/US2021/045179

§ 371 Date: Feb. 21, 2023

Related U.S. Application Data
(60) Provisional application No. 63/069,194, filed on Aug. 24, 2020.

(51) Int. Cl. C03B 5/225; C03B 5/193; C03B 5/183

(52) U.S. Cl. CPC C03B 5/225; C03B 5/193; C03B 5/183

(57) ABSTRACT

A method of minimizing the formation of a rhodium-platinum defect in a glass or glass ceramic material or in the melt thereof is provided. The method includes providing a vessel made of a platinum-rhodium alloy for use in a manufacturing process for obtaining the material, and an interface between the vessel and the melt is present. The method can include providing sufficient partial pressures of hydrogen outside and inside the vessel for controlling the partial pressure of oxygen in a region of the melt adjacent to the interface. A method of minimizing the formation of, or counteracting the impact of, a localized thermal, electrical, or composition cell in the melt during a manufacturing process is also provided. The method can include adding a multivalent compound to the melt, adding a mixer to the finer tube, adding a mixing step to the manufacturing process, or amplifying the mixing.

This application is a national stage entry of International Patent Application Serial No. PCT/US2021/045179, filed on Aug. 9, 2021, which in turn, claims the benefit of priority under 35 U.S.C. § 119 of U.S. Provisional Application Ser. No. 63/069,194 filed on Aug. 24, 2020, the contents of which are relied upon and incorporated herein by reference in their entireties.

### BACKGROUND

The present disclosure relates to a method of minimizing the formation of glass defects during a manufacturing process involving precious metal systems, and more particularly to minimizing the formation of rhodium-rich defects in a glass or glass ceramic material during the manufacturing process.

Many glass materials are manufactured in a process that involves melting, fining, delivery, mixing, and/or forming vessels made out of platinum or platinum alloys. Platinum or platinum alloys are used in such vessels that hold, channel, and form the molten glass because they have the necessary properties, such as a high melting point, strength, and resistance to corrosion, to withstand the extreme environment of molten glass (melt). Precious metals like platinum and platinum alloys are generally considered to be inert with respect to the glass at high temperatures, but oxidations, reductions, or other reactions can occur at the melt-metal interface inside the vessel and those reactions can lead to the generation of defects in the melt and the glass products obtained therefrom.

Rhodium can be alloyed with platinum to increase the strength and extend the life of the manufacturing vessels. Rhodium defects have been previously identified in some glasses, however, the defects were transitory rather than persistent, or did not appear in a quantity sufficient to warrant mitigation schemes. Eliminating rhodium from the system and using another suitable precious metal alloy may be an option for certain glasses, but that option is generally unacceptable for glasses with higher melting temperatures.

### SUMMARY

In various embodiments, a method of minimizing the formation of a rhodium-platinum defect in a glass or glass ceramic material is provided. The method can include providing a vessel made of a platinum-rhodium alloy for use in a manufacturing process for obtaining the material, wherein an interface between the vessel and a melt of the material is present. The method can include providing a partial pressure of hydrogen outside the vessel relative to a partial pressure of hydrogen inside the vessel in an amount sufficient to control the partial pressure of oxygen in a region of the melt adjacent to the interface. In the various embodiments, the rhodium-platinum defect can be rhodium-rich and the platinum-rhodium alloy in the vessel can be platinum-rich.

In some embodiments, the rhodium-platinum defect can include about 80% rhodium and about 20% platinum, and the platinum-rhodium alloy in the vessel can include about 80% platinum and about 20% rhodium.

In some embodiments, the material produced by the method of minimizing a rhodium-platinum defect is provided. In such embodiments, the material can be substantially free of the rhodium-platinum defect.

In various embodiments, a method of minimizing the formation of, or counteracting an impact of, a localized thermal, electrical, or composition cell in a glass or glass ceramic material is provided. The method can include providing a vessel made of a platinum-rhodium alloy for use in a manufacturing process, in which an interface between the vessel and a melt of the material is present. The method can include at least one step selected from adding a multivalent compound to the melt, stirring the melt in a fining vessel of the manufacturing process, and stirring the melt immediately after it exits the fining vessel.

In some embodiments, the formation of the electrical, thermal or composition cell can result in the formation of a rhodium-platinum defect. In some embodiments, the defect can be rhodium-rich and the platinum-rhodium alloy in the vessel is platinum-rich. In some embodiments, the defect can include about 80% rhodium and about 20% platinum, and the platinum-rhodium alloy in the vessel can include about 80% platinum and about 20% rhodium. In such embodiments, the material can be substantially free of the rhodium-platinum defect.

In some embodiments, the material produced by the method of minimizing the formation of, or counteracting an impact of, a localized thermal, electrical, or composition cell is provided. In some embodiments, the material includes a multivalent species. In some embodiments, the material can include more than 0.1 wt. % of tin oxide (SnO₂), iron oxide (Fe₂O₃), manganese oxide (MnO₂), cerium oxide (Ce₂O₃), or a combination thereof. In some embodiments, the material can include at least 0.05 wt. % of the combined amount of antimony oxide (Sb₂O₃) and arsenic oxide (As₂O₃).

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 (Prior Art) is a schematic drawing illustrating the construction of a glass delivery system in a down-draw fusion process for making glass sheets;

FIG. 2 is a cross-sectional view of an exemplary vessel, in accordance with embodiments herein;

FIG. 3 is an optical microscopy image of a crystalline rhodium platinum defect found in glass or glass ceramic materials, in accordance with embodiments herein;

FIG. 4 is an optical microscopy image of a crystalline rhodium platinum defect found in glass or glass ceramic materials, in accordance with embodiments herein;

FIG. 5 is a cross-sectional image of a crystalline rhodium platinum defect found in glass or glass ceramic materials obtained using a scanning electron microscope, in accordance with embodiments herein;

FIG. 6 is a spectrum of a crystalline rhodium platinum defect obtained from a scanning electron microscope (SEM) and energy-dispersive X-ray spectroscopy (EDS), in accordance with embodiments herein;

FIG. 7A is a scheme showing the steps involved in the formation of crystalline rhodium-platinum defects as the melt progresses through the manufacturing system, along with an inset thereof, in accordance with embodiments herein;

FIG. 7B is a graph corresponding to FIG. 7A showing the temperature of the melt and the partial pressure of oxygen as a function of temperature, as the melt progresses through the manufacturing system, in accordance with embodiments herein;

FIG. 8A depicts the exchange of hydrogen through the platinum rhodium wall of the vessel from the melt inside the vessel to the gas atmosphere surrounding the vessel, in accordance with embodiments herein;

FIG. 8B depicts the exchange of hydrogen through the platinum rhodium wall of the vessel from the gas atmosphere surrounding the vessel to the melt inside the vessel, in accordance with embodiments herein;

FIG. 9A depicts the formation of a composition cell at the interface of the melt and the vessel wall in the manufacturing system, in accordance with embodiments herein;

FIG. 9B depicts the formation of an electrical cell at the interface of the melt and the vessel wall in the manufacturing system, in accordance with embodiments herein;

FIG. 9C depicts the formation of a thermal cell at the interface of the melt and the vessel wall in the manufacturing system, in accordance with embodiments herein; and

FIG. 10 depicts an experimental concentration cell, in accordance with embodiments herein.

The drawings are not necessarily to scale, and certain features and certain views of the drawings may be shown exaggerated in scale or in schematic in the interest of clarity and conciseness.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

Unless otherwise expressly stated, any method set forth herein is not to be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the term “about” means that amounts, sizes, formulations, parameters, and other quantities or characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint. In some embodiments, “about” denotes values within 10% of each other, such as within 5% of each other, or within 2% of each other.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” denotes values within about 10% of each other, such as within about 5% or within about 2% of each other.

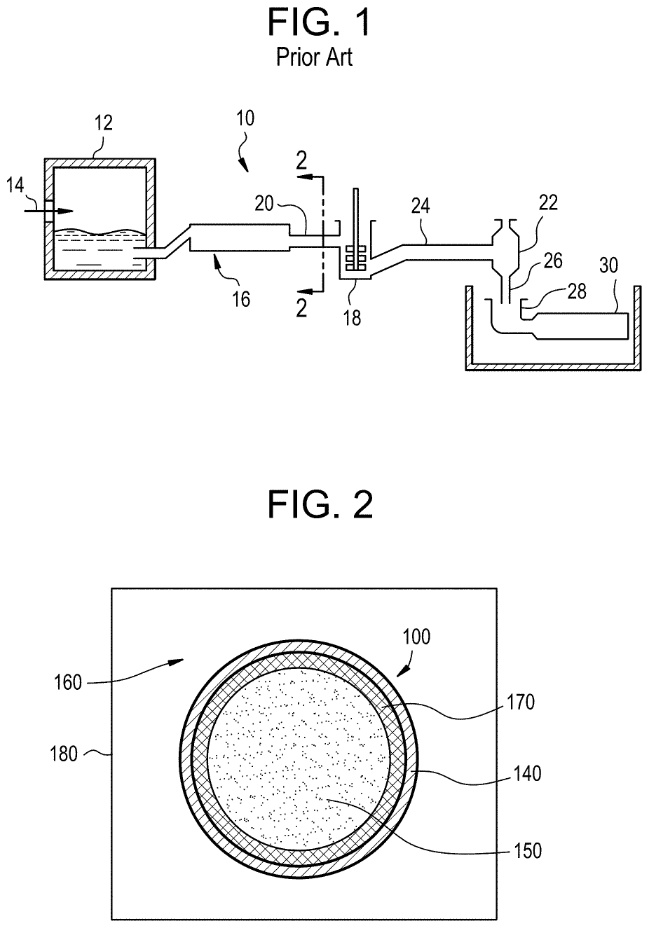

As used herein, “vessel” includes a component used in the apparatus or system for manufacturing glass or glass ceramic materials, including a melting chamber, fining tube, forming chamber, or any connecting pipe between such vessels. Typical components in a glass manufacturing system are described in U.S. Pat. No. 7,032,412, the content of which is hereby incorporated by reference in its entirety. As shown in FIG. 1 (prior art), the apparatus (10) includes a melting chamber (12), where batch materials are introduced, as shown by arrow (14), a finer tube (16), a stir chamber (18), a finer to stir chamber connecting tube (20), a bowl (22), a stir chamber to bowl connecting tube (24), a downcomer (26), an inlet (28), and a fusion pipe (30). Many of the vessels are made from refractory materials such as platinum or platinum-containing alloys (e.g., platinum-rhodium).

As used herein “higher temperature” refers to a temperature in the range of about 1400° C. to about 1600° C., and “lower temperature” refers to a temperature in the range of about 1000° C. to about 1350° C.

In various embodiments, a process of manufacturing a high alkali glass is disclosed. In some embodiments, the process includes the manufacture of other glass materials, glass ceramic, and/or ceramic materials. In such processes, persistent and novel defects have been identified in the material. The defects are highly reflective and, despite being typically less than 100 microns in diameter, they can be seen down to 2 μm in diameter in polished glass. A glass having the defect is unacceptable for many applications, including, e.g., the use of the material in a display, protective cover glass, or as a substrate.

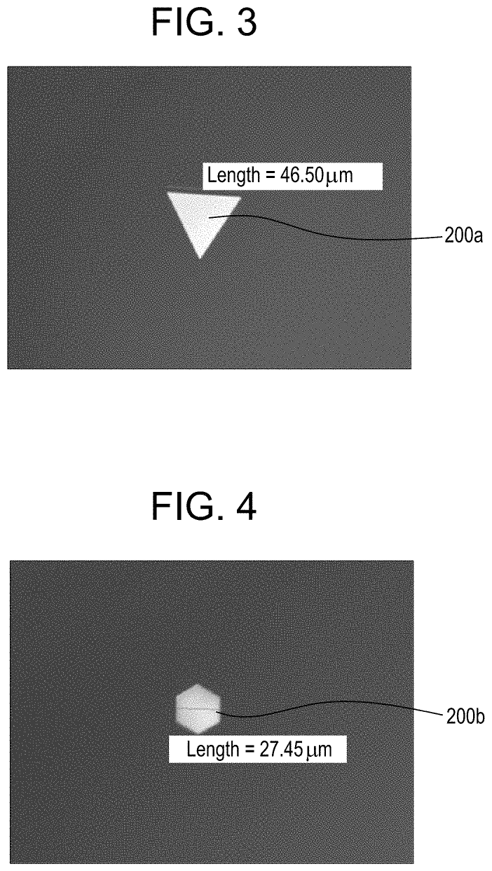

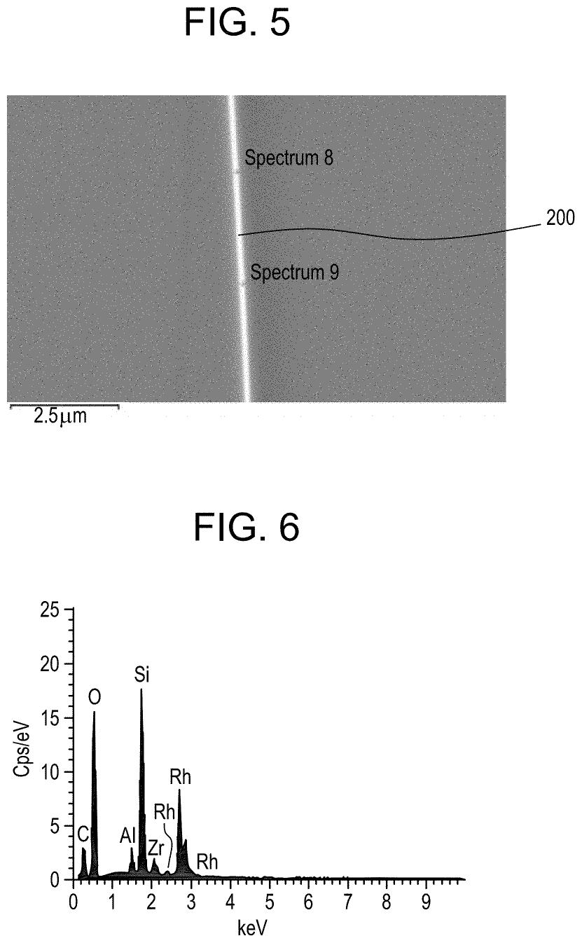

In some embodiments, the defects are thin sheets of crystalline rhodium-platinum (Rh/Pt) (also referred to herein as “cRh”). The cRh defects have regular geometry (e.g., triangle, hexagon), and have a thin, substantially planar cross-section thickness. FIG. 3 and FIG. 4 are optical microscopy images of typical cRh defects found in the glass or glass ceramic material. The defect in FIG. 3 has a triangle shape with approximately three equal sides having a length between vertices of about 46.50 μm, and the defect in FIG. 4 has a hexagon shape with a length across the transverse plane from one side to the opposite parallel side of about 27.45 μm. FIG. 5 is a cross-sectional image of an exemplary cRh defect obtained using a scanning electron microscope (SEM). FIG. 5 shows that the cRh defect (200) has a flat shape and a width (thickness of the defect) of less than 1 μm.

In some embodiments, the composition of the cRh defects was determined using a combination of SEM and energy-dispersive X-ray spectroscopy (EDS). FIG. 6 is a typical result for the cRh defect. The SEM-EDS spectrum in FIG. 6 reveals that the cRh defect is rhodium-rich, not platinum-rich as typically seen for precious metal defects in other materials. As used herein, “rhodium-rich” means the defect comprises a higher concentration of rhodium than the concentration of another component. In particular, the composition was determined to be about 80% rhodium and about 20% platinum (80 Rh/20 Pt). This result is the opposite of typical platinum-rhodium defects having about 80% platinum and about 20% rhodium (80 Pt/20 Rh), which is the same composition that the platinum-rhodium vessels are constructed of. The different chemical signature of the cRh defects is an important differentiator between these cRh defects and the typical metal defects discussed above.

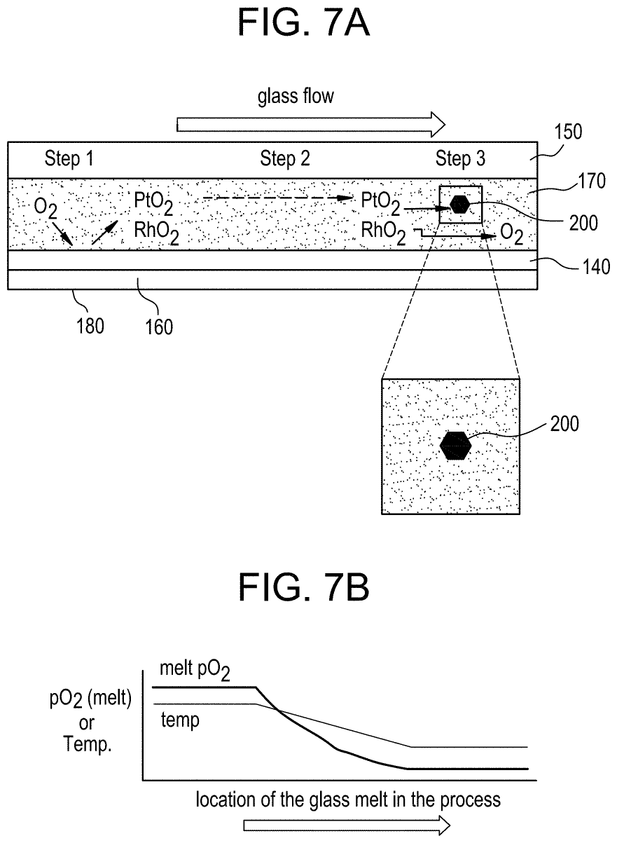

Without being bound by a particular scientific theory, the cRh defects are thought to be produced via a three step process in the melt as illustrated in FIG. 2 and FIG. 7A. FIG. 2 shows a cross-sectional view of an exemplary vessel (100) used in a glass manufacturing process (e.g., a cross-section of the finer tube (16) taken along line 2-2 of FIG. 1). In FIG. 2, the vessel (100) is enclosed in an enclosure (180) having a gas atmosphere (160). Inside of the vessel wall (140) is the bulk melt (150) and a local melt (170) adjacent to the vessel wall (140).

In FIG. 7A, the first step comprises the oxidation of platinum and rhodium at the interface of the melt (150) and the vessel wall (140) (e.g., finer tube wall), which produces platinum oxide (PtO₂) and rhodium oxide (RhO₂), which dissolve in the melt. The matrix of dots and shading indicate the relative concentrations of platinum oxide and rhodium oxide in the local melt (170). FIG. 7A shows the concentration of the oxides is highest in the melt adjacent to the vessel wall (140) and upstream in the process, where the temperatures are higher. The second step comprises the transport of the dissolved platinum oxide and rhodium oxide to other locations in the melt by diffusion and/or convection. The third step comprises a reduction of the platinum oxide and rhodium oxide to reduced platinum and rhodium species. The reduction reactions can lead to a precipitation of crystalline rhodium-platinum (cRh) when the melt containing the oxides reaches a location where the melt is sufficiently supersaturated with platinum and rhodium species, which have a lower solubility than their corresponding oxides. The inset in FIG. 7A shows the relative concentrations of platinum oxide and rhodium oxide in the melt are depleted in the region around the newly precipitated cRh defect.

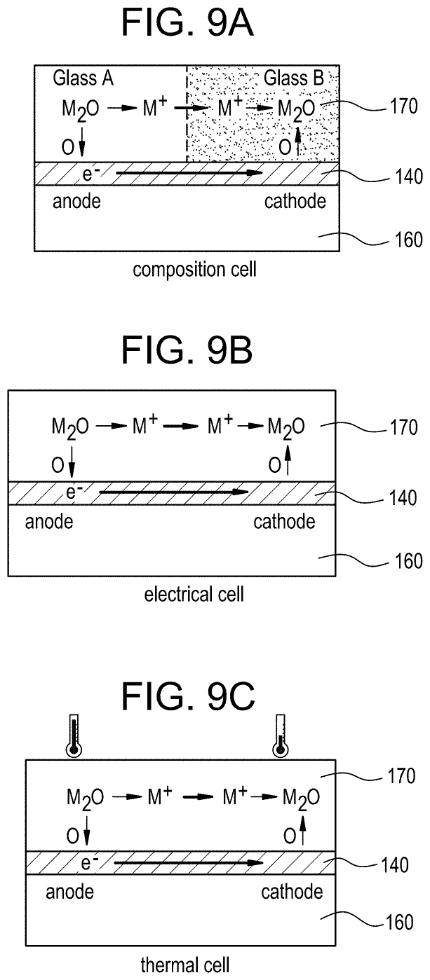

FIG. 7B shows the temperature (temp) and partial pressure of oxygen (pO₂(melt)) in the local melt (170) (y-axis) as a function of its location in the manufacturing process (x-axis). Specifically, the pO₂ decreases at lower temperatures, which is usually after the melt is processed through the finer tube. Accordingly, the oxidation reaction in the first step is likely to occur upstream in the manufacturing process where the temperature and pO₂ of the local melt are each higher, which are also the conditions that increase the solubility of platinum oxide and rhodium oxide in the melt. By contrast, the third step is likely to occur downstream in the process where the temperature and pO₂ in the local melt are lower, the conditions that decrease the solubility of platinum oxide and rhodium oxide in the melt. However, it is also possible for the first and third steps to occur in close proximity to each other. For example, when an electrochemical cell creates local areas of oxidized and/or reduced melt adjacent to the PtRh wall. FIGS. 9A-C show that electrochemical cells can be created by unintended compositional, electrical, or thermal cells in the process.

The cRh defects formed via the aforementioned three-step process are rhodium-rich because the solubility of rhodium is much greater than the solubility of platinum in the local melt (170). For example, when an 80 Pt/20 Rh alloy is exposed to various glass melts at a high temperature, the melt can pick up 2 to 10 times more rhodium oxide than platinum oxide species. As a result, when this glass is subsequently cooled and/or experiences a lower partial pressure of oxygen (pO₂) and becomes supersaturated with platinum and rhodium species, the defect that forms is enriched in rhodium. In some embodiments, the rhodium concentration in the defect is in a range of about 60% to about 90%, or about 65% to about 85%, or about 70% to about 80%, including any combination of subranges therein. This is in contrast to defects formed through a gas pathway. For example, when a 80 Pt/20 Rh alloy is exposed to an oxygen-containing gas at high temperature, the gas picks up the rhodium and platinum species in approximate proportion to their concentrations in the source alloy. Therefore, when the gas is subsequently cooled and/or experiences a lower pO₂ and becomes supersaturated, the defect that forms is platinum-rich like the source alloy.

In various embodiments, a process of minimizing the formation of cRh defects in a high alkali glass is provided. In some embodiments, the process comprises one or more steps that can be used alone or in combination during the manufacturing process to prevent, eliminate, or minimize the formation of the cRh defects in the melt.

In some embodiments, for example, the process comprises minimizing or maximizing the partial pressure of oxygen (pO₂) in the local melt. In some embodiments, the cRh defects are minimized by limiting the oxidation reaction in the first step of the three-step process for PtRh formation. In some embodiments, the cRh defects are minimized by limiting the reduction reaction and/or the precipitation of the cRh defect in the melt during the third step. In some embodiments, the process comprises limiting the oxidation reaction in the first step and limiting the reduction reaction and/or precipitation in the third step. In such embodiments, the process comprises minimizing the pO₂ in the local melt during the first step and maximizing the pO₂ in the local melt during the third step.

In such embodiments, the pO₂ in the local melt (170) (as opposed to the pO₂ in the bulk melt (150)) refers to the pO₂ of the melt adjacent to the PtRh vessel wall (140). The local melt (170) is the relevant area because the PtRh vessel wall (140) is the source of the platinum and rhodium oxides, and the dissolved oxides will remain most enriched in the melt (170) near the PtRh wall (140) due to the laminar flow of the melt through the manufacturing system. In this context, “adjacent” includes the melt in direct contact with the PtRh vessel wall (140) and a portion of the melt that is affected by an enrichment or depletion in oxygen (O₂). For example, the region of local melt (170) adjacent to the vessel wall (140) includes the melt within a spaced distance of about 2 mm from the wall, within about 1 mm from the wall, or within about 0.1 mm from the wall, or any combined range of distances thereof. In some embodiments, the local melt (170) adjacent to the vessel wall is a radial ring ranging from directly in contact with the vessel wall to about 2 mm away from the vessel wall. As would be appreciated by one skilled in the art, the size of the area of local melt (170) considered adjacent to the vessel wall depends on many factors, including the geometry, flow, and temperature of the melt.

In various embodiments, hydrogen permeation exacerbates the first and/or third step of the process that produces cRh defects by impacting the pO₂ of the melt adjacent to the PtRh wall. The PtRh walls are permeable to hydrogen, so hydrogen can exchange between the local melt (170) and the gas atmosphere (160) surrounding the PtRh wall (140). In various embodiments, the direction and the extent of hydrogen exchange, and therefore the extent of change in pO₂ of the melt adjacent to the PtRh wall (140), can be controlled by adjusting the relative values of the partial pressure of hydrogen in the gas atmosphere, pH₂(gas) (160), and the partial pressure of hydrogen in the local melt pH₂(melt) (170). Thus, in some embodiments, a mismatch between the pH₂ in the local melt (170) and the pH₂ in the gas atmosphere (160) surrounding the vessel results in hydrogen either leaving or entering the local melt from the surrounding gas atmosphere. In such embodiments, the local melt (170) adjacent to the PtRh wall becomes either enriched or depleted in O₂, as dictated by the following water reaction: H₂O↔2H+0.5O₂. For example, when a high local pH₂(melt) exists at the interface of the melt and vessel, hydrogen will permeate out of the melt into the gas atmosphere, depleting the local melt (170) of hydrogen. Based on the water reaction, for every mole of hydrogen that leaves the local melt, a ½ mole of oxygen is left behind at the interface.

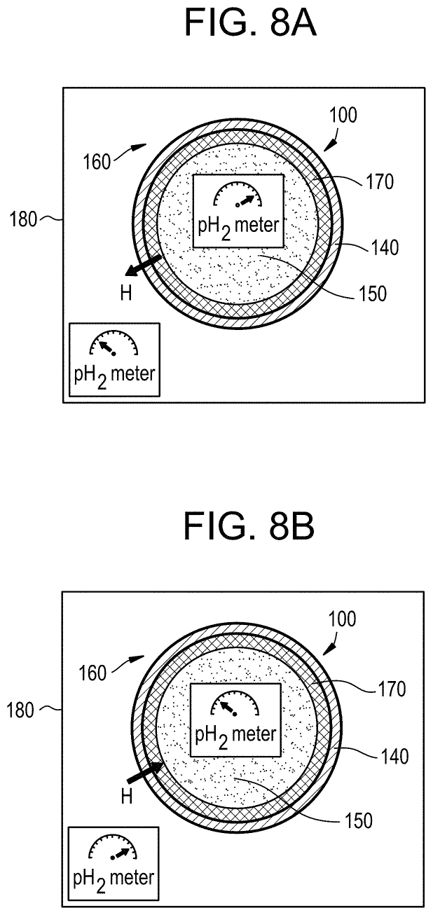

FIG. 8A shows that when pH₂(gas) is less than pH₂ (melt), hydrogen will transfer from the local melt (170) to the gas atmosphere (160), resulting in an increase in the local pO₂ of the local melt due to a shift to the right in the water reaction. In FIG. 8B, however, when pH₂(gas) is greater than pH₂(melt), hydrogen will transfer from the gas atmosphere (160) to the local melt (170) resulting in a decrease in the local pO₂ of the melt due to a shift to the left in the water reaction. In the case when the pH₂(gas) is equal to the pH₂(melt), then essentially no hydrogen transfers and the pO₂ of the local melt (170) will be substantially equal to the pO₂ in the bulk melt (150).

In some embodiments, the hydrogen exchange between the local melt (170) and the surrounding gas atmosphere (160) can be controlled by modifying the water content (β-OH) in the melt. As used herein, “β-OH” is a measure of the hydroxyl content in the glass as measured by IR spectroscopy. Specifically, β-OH is the linear absorption coefficient of the material and is calculated from the material's IR transmittance spectrum using the equation: β-OH=(1/X)LOG₁₀(T₁/T₂), in which X is the sample thickness in millimeters, T₁ is the sample transmittance at the reference wavelength (nm) and T₂ is the minimum sample transmittance of the hydroxyl absorption wavelength (nm). In some embodiments, for example, increasing the pH₂(melt) can be accomplished by increasing the water content (β-OH) of the glass. In such embodiments, the water content can be increased through various process modifications, including, for example, the addition of high-water content raw materials or batches such as those described in U.S. Pat. No. 8,623,776, the content of which is hereby incorporated by reference in its entirety, and/or the bubbling of wet gases through the bulk melt (150). As used herein, a “wet gas” refers to a gas with some amount of water vapor present. Such modifications provide a way to directly inject water into the melt, and can be appropriate during different stages of the manufacturing process, such as early in the pre-melt or later in the finer tube.

In some embodiments, the pH₂(gas) can be set to any desired value by controlling the % O₂ and dew point in the gas atmosphere (160). In some embodiments, a higher pH₂(gas) (e.g., 1% oxygen (O₂) in nitrogen (N₂) humidified to a dew point of 65° C.) can be utilized in the higher temperature upstream section (e.g., prior to and including the finer tube (16) in FIG. 1), and a lower pH₂(gas) (e.g., 1% O₂ in nitrogen (N₂) humidified to a dew point of −30° C. to −10° C.) can be used in the lower temperature downstream section (e.g., after the finer tube (16) in FIG. 1). In some embodiments, formation of the cRh defect is minimized when a gas atmosphere having a high pH₂ is replaced with one having lower pH₂, such as ambient air or 1% O₂ in N₂ with a dew point around −20° C.

In some embodiments, the gas atmosphere around the platinum-rhodium vessels is controlled by providing an enclosure (e.g., 180 in FIGS. 2, 8A, 8B) around each platinum-rhodium vessel, or an enclosure around the entire manufacturing process or portions thereof. In some embodiments, a single gas atmosphere is delivered to the entire PtRh system. In such embodiments, a lower partial pressure of hydrogen pH₂(gas) in the gas atmosphere (160) is more desirable. In some embodiments, distinct gas atmospheres are delivered to specific platinum-rhodium vessels or portions of the vessels. For example, distinct gas atmospheres or segmented vessels are configured to operate with a higher pH₂(gas) in the higher temperature upstream sections of the process to decrease the local pO₂ of the local melt (170) and minimize the oxidation of platinum and rhodium to platinum oxide and rhodium oxide; and, with a lower pH₂(gas) in the lower temperature downstream sections of the process to increase the local pO₂ of the local melt (170) and minimize the reduction of platinum oxide and rhodium oxide and/or precipitation of the cRh defect.

In some embodiments, the process comprises controlling the formation of electrical, thermal, and composition cells in the PtRh system. As shown in FIGS. 9A, 9B, and 9C, electrical, thermal, and composition cells can create areas of higher and lower pO₂ in the local melt (170) adjacent to the platinum-rhodium alloy vessel wall (140). The areas of higher and lower pO₂ in the local melt (170) exacerbate the cRh defect problem.

In some embodiments, for example, a composition cell is the sludge layer in the finer tube. As used herein, “sludge layer” refers to a layer of glass with a different composition than that of the bulk melt and typically enriched with oxides of the refractory materials from the vessel walls and electrodes. In some embodiments, the sludge layer is formed in the pre-melt by refractory brick and/or electrodes being continuously dissolved into the melt, which is then carried downstream to the finer tube and other downstream sections before the stir chamber. For example, FIG. 9A shows an area of melt on the left side (Glass A) that is different than the melt on the right side (Glass B). Each of the melt compositions are in contact with the PtRh vessel wall, and the different melt compositions in contact with the vessel wall create a local anode and cathode. This situation results in an increase in local pO₂ at the anode and a decrease in local pO₂ at the cathode. In such embodiments, the sludge layer can create a composition cell.

With reference to FIG. 9B, electrical cells can form when unintentional ground loops are present, creating a local anode and cathode along the PtRh vessel wall. At the local anode, there is an increase in local pO₂, and at the cathode, there is a decrease in local pO₂, which can cause the formation of platinum-rhodium precipitates. FIG. 9C shows that thermal cells can result from a sharp temperature gradient is present. The temperature gradient, as indicated by the different thermometer symbols, can create a local anode and cathode along the PtRh vessel wall, which results in an increase in local pO₂ at the anode and a decrease in local pO₂ at the cathode. Similar to composition cells, unintentional electrical and thermal cells can exacerbate the cRh defect problem and should be minimized in the manufacturing process.

In some embodiments, stirring the melt (150) using mixing devices that minimize composition gradients before the melt enters the cooling section is important. In some embodiments, for example, stirring devices (e.g., bubblers or static mixers) are added before and/or immediately after the finer tube to minimize the sludge layer and the development of concentration cells in the higher and lower temperature sections of the glass manufacturing process.

In some embodiments, the addition of multivalent species, such as tin, iron, etc., to the melt minimize the impact of any composition, electrical, or thermal cells that cannot be eliminated using mechanical process modifications. In such embodiments, the multivalent species counteract any local pO₂(melt) gradients and minimize the subsequent formation of cRh defects. For example, in some embodiments, the multivalent species can buffer the melt from negatively charged oxygen ions, caused by the breakdown of water or hydroxyl species in the melt, that can be converted to molecular oxygen.

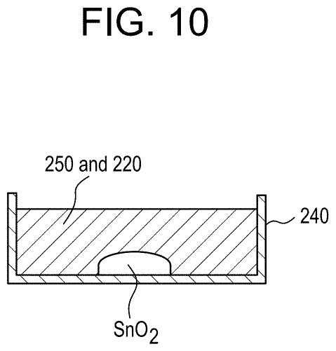

FIG. 10 shows the system (200) used to experiment with the addition of multivalent species (220) to a composition cell provided by the addition of a small line of SnO₂ powder on the bottom of a small 80 Pt-20 Rh foil crucible (240), and then covered with melt (250) containing various levels of various multivalent species. Ten different glass material compositions were included in the study, and the multivalent species included in each composition are shown in Table 1. Each of the samples were heated to 1550° C. for 48 hours, cooled to 1250° C. and held for 24 hours, and then quenched in air. The glass was then inspected for cRh defects.

TABLE 1

| Mole % | Ex. 1 | Ex. 2 | Ex. 3 | Ex. 4 | Ex. 5 | Ex. 6 | Ex. 7 | Ex. 8 | Ex. 9 | Ex. 10 |
|---|---|---|---|---|---|---|---|---|---|---|
| SiO₂ | 70.9 | 70.9 | 70.9 | 70.9 | 70.9 | 70.9 | 70.9 | 70.9 | 70.9 | 70.9 |
| Al₂O₃ | 4.3 | 4.3 | 4.3 | 4.3 | 4.3 | 4.3 | 4.3 | 4.3 | 4.3 | 4.3 |
| Li₂O | 22 | 22 | 22 | 22 | 22 | 22 | 22 | 22 | 22 | 22 |
| ZrO₂ | 2 | 2 | 2 | 8 | 2 | 2 | 2 | 2 | 2 | 2 |
| P₂O₅ | 0.8 | 0.8 | 0.8 | 0.8 | 0.8 | 0.8 | 0.8 | 0.8 | 0.8 | 0.8 |
| SnO₂ | 0 | 1 | 0 | 0 | 0.5 | 0 | 0 | 0 | 0 | 0 |
| Fe₂O₃ | 0 | 0 | 0.25 | 0 | 0 | 0.125 | 0 | 0 | 0 | 0 |
| CeO₂ | 0 | 0 | 0 | 0 | 0 | 0 | 0.1 | 0.5 | 0 | 0 |
| MnO₂ | 0 | 0 | 0 | 0 | 0 | 0 | 0 | 0 | 0.1 | 0.5 |
| cRh | Many | None | None | ZrO₂ | None | None | Some | Some | Some | Some |
| | | | | defects | | | | | | |

As shown in Table 1, the samples with the lowest concentration of multivalent species (Ex. 1) produced the highest number of metallic defects, samples with cerium or manganese additions (Ex. 8, Ex. 10) produced some defects, and samples with tin or iron additions (Ex. 2, Ex. 5; Ex. 3, Ex. 6) produced no defects. Accordingly, the tin and iron additions were very effective and the cerium and manganese additions were somewhat effective at minimizing the local pO₂ gradient (formed by the composition cell created by the SnO₂ powder in the bottom of the crucible) and subsequent formation of cRh defects. In the examples, the concentration cell formed is likely more severe than any cells observed in the glass manufacturing process due to the relatively large amount of tin oxide powder added in the examples. Therefore, smaller multivalent additions may be sufficient in a larger production vessel in combination with proper thermal and atmospheric controls.

In some embodiments, the glass or glass ceramic material comprises more than 0.1 wt % of one or more multivalent species. In some embodiments, for example, the material comprises more than 0.1 wt % SnO₂. In some embodiments, the material comprises more than 0.1 wt % Fe₂O₃. In some embodiments, the material comprises more than 0.2 wt % of the combined amounts of SnO₂, Fe₂O₃, MnO₂, and Ce₂O₃. In some embodiments, the material comprises at least 0.05 wt % of the combined amounts of Sb₂O₃ and As₂O₃. In some embodiments, the melt comprises Li₂O in a molar amount that is greater than Al₂O₃.

In some embodiments, a method of minimizing the cRh defects in a process of manufacturing a glass or glass ceramic material using one or more vessels (e.g., melting chamber, fining tube), or all vessels in the manufacturing system, are made of a precious metal or metal alloy that does not include rhodium is provided. In such embodiments, the elimination of rhodium from the system and the use of a suitable Rh-free precious metal alloy is provided for higher melting temperature glasses. In some embodiments, the dissolution of rhodium into the melt (150) is minimized or eliminated by changing the vessels from 80 Pt/20 Rh to 100 Pt. In some embodiments, the dissolution of rhodium into the melt (150) is minimized or eliminated by changing the vessels from 80 Pt/20 Rh to a platinum alloy containing another precious metal (e.g., molybdenum). In such embodiments, the formation of the cRh defects in the melt is avoided.

In various embodiments, a process of manufacturing a glass or glass ceramic material is provided. In some embodiments, the material comprises SiO₂, Al₂O₃, Li₂O, P₂O₅, ZrO₂, K₂O, and Na₂O. In various embodiments, the formation of cRh defects was minimized or eliminated through permeation control, including providing a pH₂(gas) relative to the pH₂(melt) in an amount sufficient to control the partial pressure of oxygen in a region of the melt adjacent to the interface between the melt and the vessel wall, and/or through minimizing the formation of a localized thermal, electrical, or composition cell in the melt. In various embodiments, the material comprises less than 15 cRh defects per pound, or less than 10 cRh defects per pound, or less than 5 cRh defects per pound, or less than 1 cRh defects per pound.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

We claim:

1. A method of minimizing the formation of a rhodium-platinum defect in a glass or glass ceramic material, comprising:
providing a vessel made of a platinum-rhodium alloy for use in a manufacturing process for obtaining the material, wherein an interface between the vessel and a melt of the material is present;
providing a partial pressure of hydrogen outside the vessel relative to a partial pressure of hydrogen inside the vessel in an amount sufficient to control a partial pressure of oxygen in a region of the melt adjacent to the interface;
wherein the rhodium-platinum defect is rhodium-rich and the platinum-rhodium alloy in the vessel is platinum-rich.

2. The method of claim 1, wherein the rhodium-platinum defect comprises a substantially planar geometric shape having a cross-section thickness of less than about 3 μm, and a diameter of from about 2 μm to about 150 μm.

3. The method of claim 2, wherein the rhodium-platinum defect comprises about 80% rhodium and about 20% platinum, and the platinum-rhodium alloy in the vessel comprises about 80% platinum and about 20% rhodium.

4. The method of claim 3, wherein the material comprises the rhodium-platinum defect in the absence of providing the partial pressure of hydrogen outside the vessel relative to the partial pressure of hydrogen inside the vessel in an amount sufficient to control the partial pressure of oxygen in the region of the melt adjacent to the interface.

5. The method of claim 1, wherein the partial pressure of hydrogen outside the vessel is greater than the partial pressure of hydrogen inside the vessel when the melt is at a temperature in a range of about 1400° C. to about 1600° C., and
wherein the partial pressure of oxygen is reduced in the region of the melt adjacent to the interface.

6. The method of claim 1, wherein the partial pressure of hydrogen outside the vessel is less than the partial pressure of hydrogen inside the vessel when the melt is at a temperature in a range of about 1000° C. to about 1300° C., and
wherein the partial pressure of oxygen is increased in the region of the melt adjacent to the interface.

7. The method of claim 1, comprising adding water or a hydroxide-containing compound into the melt to increase the partial pressure of hydrogen inside the vessel.

8. The method of claim 1, comprising bubbling a wet gas into the melt to increase the partial pressure of hydrogen inside the vessel.

9. A glass or glass ceramic material produced by the method of claim 1.

10. The material of claim 9, wherein the material comprises more than 0.1 wt % of a combination of tin oxide, iron oxide, manganese oxide, and cerium oxide, or at least 0.05 wt % of a combination of antimony oxide and arsenic oxide.

11. A method of minimizing the formation of, or counteracting an impact of, a localized thermal, electrical, or composition cell in a glass or glass ceramic material, comprising:
providing a vessel made of a platinum-rhodium alloy for use in a manufacturing process for obtaining the material, wherein an interface between the vessel and a melt of the material is present; and
at least one further step selected from:
adding a multivalent compound to the melt;
stirring the melt before a fining vessel of the manufacturing process; or
stirring the melt immediately after it exits the fining vessel.

12. The method of claim 11, wherein the formation of the electrical, thermal or composition cell results in a formation of a rhodium-rich defect.

13. The method of claim 12, wherein the rhodium-rich defect comprises a substantially planar geometric shape having a cross-section thickness of less than about 3 μm, and wherein the rhodium-rich defect comprises a diameter of from about 2 μm to about 150 μm.

14. The method of claim 13, wherein the rhodium-rich defect comprises about 80% rhodium and about 20% platinum, and the platinum-rhodium alloy in the vessel comprises about 80% platinum and about 20% rhodium.

15. The method of claim 14, wherein the material comprises the rhodium-platinum defect in the absence of the at least one further step.

16. The method of claim 11, wherein the at least one further step is adding a multivalent compound to the melt.

17. The method of claim 16, wherein the multivalent compound is an oxide comprising tin, iron, cerium, or manganese.

18. The method of claim 11, wherein the localized cell is a localized electrical cell resulting from a formation of a local anode and a local cathode in vessel.

19. The method of claim 11, wherein the localized cell is a localized composition cell resulting from a sludge layer and the further step is stirring the melt before a fining vessel of the manufacturing process or stirring the melt immediately after it exits the fining vessel; and
wherein the formation of the localized thermal cell is not minimized or counteracted by adding a multivalent compound to the melt.

20. The method of claim 11, wherein the localized cell is a localized thermal cell and the vessel is a fining tube.

21. A method of minimizing the formation of a rhodium-platinum defect in a glass or glass ceramic material during a manufacturing process employing a platinum-rhodium (PtRh) alloy in a vessel of the manufacturing process, wherein an interface between the vessel and a melt of the material is present, comprising:
providing a partial pressure of hydrogen outside the vessel relative to a partial pressure of hydrogen inside the vessel in an amount sufficient to control a partial pressure of oxygen in a region of the melt adjacent to the interface;
wherein the rhodium-platinum defect is rhodium-rich and the platinum-rhodium alloy in the vessel is platinum-rich.

22. The method of claim 21, wherein the rhodium-platinum defect comprises a substantially planar geometric shape having a cross-section thickness of less than about 3 μm, and a diameter of from about 2 μm to about 150 μm.

23. The method of claim 22, wherein the rhodium-platinum defect comprises about 80% rhodium and about 20% platinum, and the platinum-rhodium alloy in the vessel comprises about 80% platinum and about 20% rhodium.

24. The method of claim 23, wherein the material comprises the rhodium-platinum defect in the absence of providing the partial pressure of hydrogen outside the vessel relative to the partial pressure of hydrogen inside the vessel in an amount sufficient to control the partial pressure of oxygen in the region of the melt adjacent to the interface.
